(19) United States
(12) Patent Application Publication
(10) Pub. No.: US 2018/0192808 A1
(43) Pub. Date: Jul. 12, 2018

(54) FOOD WARMING APPLIANCE SPECIFICALLY FOR WARMING CHEESE OR OTHER SEMI-SOLID SUBSTANCES OR PRODUCTS, AND A CHEESE DISPENSING STATION COMPRISING THE APPLIANCE AND GUN

(71) Applicants: CHERYL L. PANASIK, Elburn, IL (US); Bhupendra R. Patel, Carol Stream, IL (US); Thomas Walter Orzechowski, Carol Stream, IL (US)

(72) Inventors: CHERYL L. PANASIK, Elburn, IL (US); Bhupendra R. Patel, Carol Stream, IL (US); Thomas Walter Orzechowski, Carol Stream, IL (US)

(21) Appl. No.: 15/402,033

(22) Filed: Jan. 9, 2017

(51) Int. Cl. A47J 27/14; H05B 3/06

(52) U.S. Cl. CPC A47J 27/14; H05B 3/06; B05C 17/0123; H05B 2203/003; H05B 2203/03

(57) ABSTRACT

A new and improved food warming appliance comprises a housing within which a multiplicity of elongated sanitary sleeves or cups are adapted to be removably mounted and within which cheese dispensing guns are adapted to be respectively disposed. Respectively surrounding each one of the elongated sanitary sleeves or cups is an elongated aluminum tube, and respectively surrounding each one of the elongated aluminum tubes is an elongated flexible foil tube which has a heating strip operatively associated therewith. To complete the assembly, a suitable elongated tubular insulation sleeve respectively surrounds each one of the elongated flexible foil tubes. In this manner, when the heating strips of the foil heaters are energized, heat is transmitted radially inwardly from the foil heaters, to the aluminum tubes, and then to the sanitary sleeves or cups for, in turn, heating the dispensing guns whereby, for example, the semi-solid cheese products, disposed within the cheese dispensing guns, are sufficiently heated to predetermined temperatures which not only melt the cheese products and provide the same with the requisite fluidity for easy and reliable dispensing, but also renders the cheese products safe for consumption. Still further, a food dispensing station is formed by the food warming appliance and the dispensing guns.

### FIELD OF THE INVENTION

The present invention relates generally to food warming appliances, and more particularly to a food warming appliance which may be utilized in connection with the warming of cheese, or other semi-solid products, that may be dispensed onto food products as a condiment or the like within restaurant establishments. Specifically, the new and improved food warming appliance has been developed for use with a cheese or other food product dispensing gun and comprises a housing within which a multiplicity of elongated sanitary sleeves or cups are adapted to be removably mounted, and within which cheese dispensing guns are adapted to be respectively disposed when the dispensing guns are not being used to dispense their cheese products. The removable sanitary sleeves or cups are provided so as to collect any drops of melted cheese that may effectively be discharged from the dispensing end of the dispensing gun after a cheese dispensing operation has been terminated and the dispensing gun has been returned to the removable sanitary sleeve or cup in readiness to be utilized for a subsequent cheese dispensing operation. The removability of the sanitary sleeves or cups permits the same to be readily removed, cleaned, and re-inserted into the appliance, or to be replaced within the appliance by means of freshly cleaned sanitary sleeves or cups. Respectively surrounding each one of the elongated sanitary sleeves or cups is an elongated aluminum tube, and respectively surrounding each one of the elongated aluminum tubes is an elongated flexible foil tube which has a heating strip operatively associated therewith. To complete the assembly, a suitable elongated tubular insulation sleeve respectively surrounds each one of the elongated flexible foil tubes. In this manner, when the heating strips of the foil heaters are energized, heat is transmitted radially inwardly from the foil heaters, to the aluminum tubes, and then to the sanitary sleeves or cups which, in turn, impart heat to the dispensing guns whereby the semi-solid cheese products, disposed within the cheese dispensing guns, are sufficiently heated to predetermined temperatures so that the cheese products are not only melted such that the cheese products are provided with the requisite fluidity for easy and reliable dispensing, but the heat also renders the cheese products safe for consumption. A cheese dispensing station is also formed by means of the food warming appliance and the dispensing guns.

### BACKGROUND OF THE INVENTION

Various conventional cheese dispensing appliances are of course well-known, however, some of them have exhibited various undesirable and unreliable operational problems. One of the more significant problems, for example, is that the appliances, which may be hand-powered or have electrical-powered pump mechanisms disposed therein, often do not expel all of the cheese disposed within the appliances, thereby leaving a significant amount of residual cheese product within the appliance. This residual cheese product effectively comprises waste which, in and of itself, is expensive and therefore dramatically increases the operational costs of the particular restaurant, but, in addition, such residual cheese must be manually removed from the appliance because it cannot be readily dispensed from the appliance. A dispensing gun would ideally serve as a dispensing appliance for cheese or other food products, however, to date, an appliance has not been sufficiently developed in order to maintain a dispensing gun appliance sufficiently heated or warmed in order to effectively render the cheese or similar food product, disposed within the gun, sufficiently heated or warmed so as to facilitate the proper dispensing of the cheese or similar food product. The cheese or similar food product is normally disposed internally within the appliance as a semi-solid, and, as such, must be sufficiently melted whereby the cheese or food product attains sufficient fluidity characteristics so as to in fact be capable of being easily dispensed onto, for example, food products as a condiment or the like such that the cheese or similar food product is not in fact dispensed in lumps or globs.

A need therefore exists in the art for a new and improved food warming appliance wherein the aforenoted disadvantages or operational drawbacks characteristic of conventional food warming appliances are effectively overcome or eliminated. More particularly, a need exists in the art for a new and improved food warming appliance which is specifically designed to be operatively associated with a food product dispensing gun. Even more particularly, a need exists in the art for a new and improved food warming appliance for specifically warming the cheese or similar food product, disposed within the dispensing gun, to a predetermined temperature such that the amount of cheese remaining in the dispensing gun is minimized. In addition, a need exists in the art for a new and improved food warming appliance wherein the cheese or similar food product is properly melted whereby the cheese or food product is provided with sufficient fluidity so as to be capable of being dispensed onto food products as a condiment or the like. Still more particularly, a need exists in the art for a new and improved food warming appliance for specifically warming the cheese or other food product to a predetermined temperature such that the cheese is properly melted whereby the cheese is provided with sufficient fluidity so as not to be dispensed in clumps or globs. Yet more particularly, a need exists in the art for a new and improved food warming appliance for specifically warming cheese or food product to a predetermined temperature such that the cheese or food product is properly melted whereby the cheese is provided with sufficient fluidity so as not to clog a cheese dispensing gun. Furthermore, a need exists in the art for a new and improved food warming appliance for specifically warming cheese or other food product to a predetermined temperature whereby the cheese will be safe for consumption. Yet further, a need exists in the art for a new and improved food warming appliance wherein the appliance is relatively small in size. Still further, a need exists in the art for a new and improved food warming appliance wherein the appliance may be mounted at or upon various dispensing stations conveniently located within and throughout a fast food or other type of food establishment.

### OVERALL OBJECTIVES OF THE INVENTION

The overall objectives of the present invention are to provide a new and improved food warming appliance which, will overcome or eliminate the aforenoted disadvantages or operational drawbacks characteristic of conventional food warming appliances, to provide a new and improved food warming appliance which is specifically constructed for operation with a food product dispensing gun, to provide a new and improved food warming appliance for minimizing the amount of residual cheese remaining within the cheese or food product dispensing gun, to provide a new and improved food warming appliance which significantly reduces the operational costs associated with cheese dispensing appliances or guns, to provide a new and improved food warming appliance for specifically warming cheese, soups, sauces, and other foods to a predetermined temperature such that the cheese or other food product is properly melted whereby the cheese or other food product is provided with sufficient fluidity so as to be capable of being dispensed onto food products as a condiment, to provide a new and improved food warming appliance for specifically warming cheese or other food product to a predetermined temperature such that the cheese or other food product is properly melted whereby the cheese is provided with sufficient fluidity so as not to be dispensed in clumps or globs, to provide a new and improved food warming appliance for specifically warming cheese or other food product to a predetermined temperature such that the cheese is properly melted whereby the cheese is provided with sufficient fluidity so as not to clog the dispensing gun, to provide a new and improved food warming appliance for specifically warming cheese or other food product to a predetermined temperature whereby the cheese will be safe for consumption, to provide a new and improved food warming appliance wherein the appliance is relatively small in size, and to provide a new and improved food warming appliance wherein the appliance may be mounted at or upon various dispensing stations conveniently located within and throughout a fast food or other type of food establishment.

### SUMMARY OF THE INVENTION

The foregoing and other objectives are achieved in accordance with the teachings and principles of the present invention through the provision of a new and improved food warming appliance wherein, in accordance with a primary embodiment of the appliance, the appliance comprises a housing within which a multiplicity of elongated sanitary sleeves or cups are adapted to be removably mounted, and within which cheese dispensing guns are adapted to be respectively disposed when the dispensing guns are not being used to dispense their cheese products. The removable sanitary sleeves or cups are provided so as to collect any drops of melted cheese that may effectively be discharged from the dispensing end of the dispensing gun after a cheese dispensing operation has been terminated and the dispensing gun has been returned to the removable sanitary sleeve or cup in readiness to be utilized for a subsequent cheese dispensing operation. The removability of the sanitary sleeves or cups permits the same to be readily removed, cleaned, and re-inserted into the appliance or to be replaced within the appliance by means of freshly cleaned sanitary sleeves or cups. Respectively surrounding each one of the elongated sanitary sleeves or cups is an elongated aluminum tube, and respectively surrounding each one of the elongated aluminum tubes is an elongated flexible foil tube which has a heating strip operatively associated therewith.

To complete the assembly, a suitable elongated tubular insulation sleeve respectively surrounds each one of the elongated flexible foil tubes. In this manner, when the heating strips of the foil heaters are energized, heat is transmitted radially inwardly from the foil heaters, to the aluminum tubes, and then to the sanitary cups or sleeves which, in turn, impart heat to the dispensing guns whereby, for example, the semi-solid cheese products, disposed within the cheese dispensing guns, are sufficiently heated to predetermined temperatures so that the cheese products are not only melted such that the cheese products are provided with the requisite fluidity for easy and reliable dispensing, but the heat also renders the cheese products safe for consumption. Other contemplated embodiments of the invention appliance will also be disclosed within the detailed portion of this specification, as well as within the drawings. Still further, a food dispensing station is formed by means of the food warming appliance and the dispensing guns.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a side elevational view of a first type of conventional food or cheese dispensing gun which may be utilized in conjunction with the food or cheese warming appliance of the present invention;

FIG. 2 is a perspective view of a second type of conventional food or cheese dispensing gun which may also be utilized in conjunction with the food or cheese warming appliance of the present invention;

FIG. 3 is an exploded view of a first embodiment of a new and improved food product or cheese warming appliance as constructed in accordance with the principles and teachings of the present invention and illustrating the various operative components thereof;

FIG. 4 is a perspective view of a first embodiment of a stand-alone food station having a food warming appliance, as constructed in accordance with the principles and teachings of the present invention, mounted upon an undersurface portion of the stand-alone food station;

FIG. 5 is a perspective view of a second embodiment of a stand-alone food station wherein the housing itself of the food warming appliance has been oriented so as to effectively support the food warming appliance upon a floor surface whereby the food warming appliance serves as a stand-alone food station;

FIG. 6 is a perspective view of a third embodiment of a stand-alone food station wherein the housing itself of the food warming appliance has been oriented so as to effectively support the food warming appliance upon a floor surface whereby the food warming appliance serves as a stand-alone food station; and

FIG. 7 is a schematic cross-sectional view of a second embodiment of a new and improved food product or cheese warming appliance as constructed in accordance with the principles and teachings of the present invention and illustrating the various operative components thereof.

### DETAILED DESCRIPTION OF THE ILLUSTRATED EMBODIMENTS

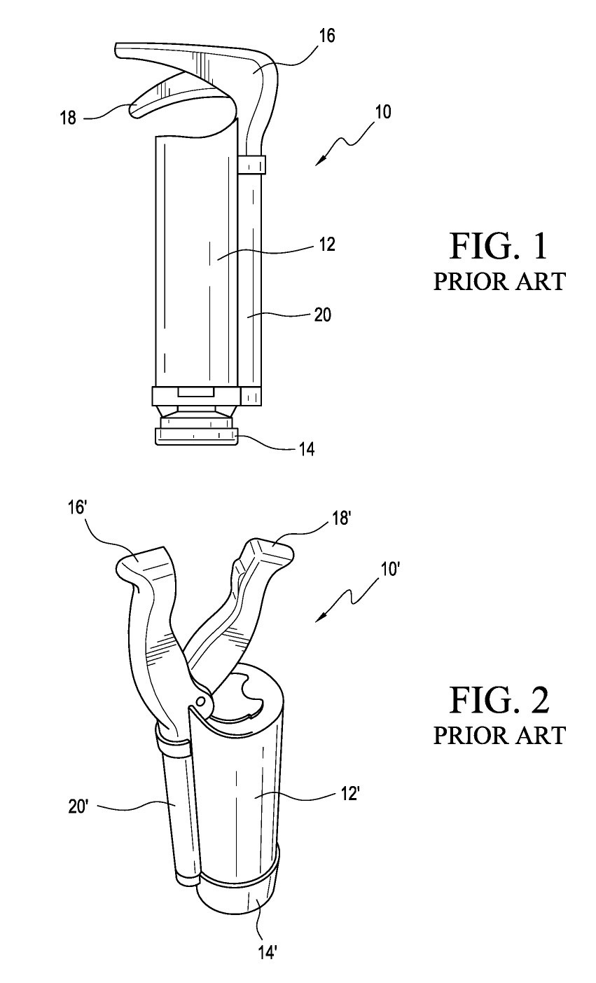

Referring now to the drawings, and more particularly to FIG. 1 thereof, a first type of conventional food or cheese dispensing gun, which may be utilized in conjunction with the food or cheese warming appliance of the present invention, is disclosed and is generally indicated by the reference character 10. As is well known, the conventional dispensing gun 10, which is similar to a conventional caulking gun, is seen to comprise a barrel 12 upon the distal end of which there is operatively disposed a dispensing nozzle assembly 14, while a handle 16 is fixedly mounted upon a proximal end of the barrel 12. The barrel 12 has a supply of a food product, such as, for example, cheese, disposed therein in the form of a compressible pouch, not shown, and an indexing mechanism, comprising rack and pinion components, also not shown, is operatively associated with the pouch. In particular, as is also well known, the rack and pinion mechanism has a pusher-plate operatively connected thereto. A trigger mechanism 18 is pivotally mounted upon the handle 16 and is operatively connected to the rack and pinion components. Accordingly, as is also well known, whenever the trigger mechanism 18 is actuated, the rack and pinion components serve to incrementally move the pusher-plate within the barrel 12 so as to, in turn, incrementally compress the pouch containing the cheese food product whereby the cheese food product is then dispensed from the dispensing nozzle assembly 14. The rack component of the rack and pinion assembly mechanism is housed within a semi-cylindrical secondary barrel portion 20 that is integrally attached to the primary barrel portion 12. As illustrated within FIG. 2, a second type of conventional food or cheese dispensing gun, which may also be utilized in conjunction with the food or cheese warming appliance of the present invention, is disclosed and is generally indicated by the reference character 10′. The various structural components of the second type of conventional food or cheese dispensing gun 10′, which correspond to the various structural components of the first type of conventional food or cheese dispensing gun 10, are denoted by means of similar reference numbers except that they are additionally denoted by means of apostrophe (′) characters.

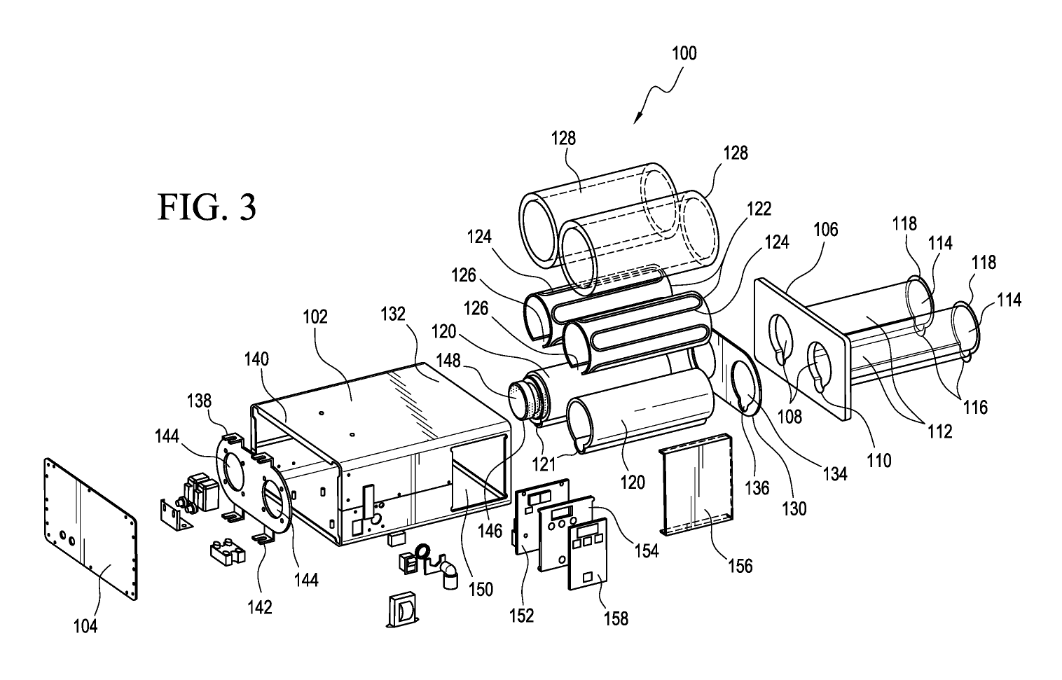

With reference now being made to FIG. 3, there is illustrated, in an exploded view format, a first primary embodiment of a food warming appliance which has been constructed in accordance with the principles and teachings of the present invention and which is disclosed by means of the reference character 100. More particularly, it is seen that the food warming appliance 100 is seen to comprise a hollow housing 102 which, in accordance with the principles and teachings of this first primary embodiment of the food warming appliance, has the configuration of a rectangular parallelepiped. The housing 102 is seen to comprise a solid end plate 104 which is adapted to be fixedly secured to the distal end of the housing 102 so as to effectively close the same, while a face plate 106 is adapted to be fixedly secured to the proximal end of the housing 102. The face plate 106 has a pair of primary apertures 108 defined within laterally spaced central portions of the face plate 106, wherein the pair of primary apertures 108 each have an opening having a substantially circular configuration, although in addition to the primary openings or apertures 108, a pair of secondary semi-circular openings or slots 110 are also defined within the face plate 106 such that the pair of secondary semi-circular openings or slots are connected to lower portions of the primary apertures 108, as viewed in the drawing, for a reason which will become more readily apparent shortly hereinafter.

A pair of elongated hollow sanitary sleeves or cups 112, fabricated from a suitable thermoplastic material, are adapted to be removably mounted upon the face plate 106 such that the pair of elongated hollow sanitary sleeves or cups 112 respectively extend through the primary and secondary apertures 108,110 defined within the face plate 106 whereby the pair of elongated hollow sanitary cups or sleeves 112 extend into the hollow interior portion of the housing 102. It is to be noted that each one of the elongated hollow sanitary cups or sleeves 112 has a cross-sectional configuration which comprises a primary tubular body portion closed at the distal end thereof, which is not visible in the drawing, while the proximal end of each one of the elongated hollow sanitary sleeves or cups 112 is provided with a primary opening 114 which has a substantially circular configuration that has an external diametrical extent that is slightly smaller than the internal diametrical extent of each one of the primary openings or apertures 108 defined within the face plate 106 such that the primary tubular body portions of the elongated hollow sanitary sleeves or cups 112 can in fact pass through the primary openings or apertures 108 defined within the face plate 106. In a similar manner, it is likewise seen that each one of the elongated hollow sanitary sleeves or cups 112 also has a secondary semi-circular elongated channel portion 116 integrally formed with the lower side wall portion of the elongated hollow sanitary sleeve or cup 112 wherein the channel portion 116 extends the entire axial length of the elongated hollow sanitary sleeve or cup 112. It is to be appreciated that the channel portion 116 of each one of the elongated hollow sanitary sleeve or cup 112 is sized so as to be accommodated within and able to pass through each one of the secondary apertures 110 defined within the face plate 106.

It is lastly seen and to be appreciated that the open proximal ends of each one of the elongated hollow sanitary sleeves or cups 112 is also provided with a radially outwardly projecting circumferentially extending flange or lip 118 such that when each one of the elongated hollow sanitary sleeves or cups 112 is removably mounted upon the face plate 106 of the housing 102, the radially outwardly projecting circumferentially extending flange or lip portions 118 will encounter the face plate 106 such that the extent or depth to which the elongated tubular body portions of the elongated hollow sanitary sleeves or cups 112 can extend into and be disposed internally within the housing 102 is predetermined. It can now therefore be additionally appreciated that the unique configurations of the elongated hollow sanitary cups or sleeves 112 and the openings within the face plate 106, including the primary openings 114 and the channel portions 116 of the elongated hollow sanitary cups or sleeves 112, as well as the configurations of the primary and secondary openings 108,110 defined within the face plate 106, readily permit the insertion and accommodation of the primary and secondary barrel portions 12,12′,20,20′ of the cheese dispensing guns 10,10′, disclosed within FIGS. 1 and 2, when the cheese dispensing guns 10,10′ are not being used to dispense cheese products and are disposed within the appliance 100 so as to be heated thereby which will be further discussed hereinafter. It is to be additionally noted that the removable sanitary sleeves or cups 112 are provided so as to collect any drops of melted cheese that may effectively be discharged from the dispensing ends of the dispensing guns 10,10′ after a cheese dispensing operation has been terminated and the dispensing guns have been returned to the removable sanitary sleeves or cups 112 in readiness to be utilized for a subsequent cheese dispensing operation. The removability of the sanitary sleeves or cups 112 permits the same to be readily removed, cleaned, and re-inserted into the appliance 100, or alternatively, to be replaced within the appliance 100 by means of freshly cleaned sanitary sleeves or cups 112.

Continuing further, and with reference still being made to FIG. 3, it is seen that in addition to the pair of elongated sanitary sleeves or cups 112, the warming appliance 100 of the present invention also includes a pair of elongated hollow aluminum tubes 120 which have cross-sectional configurations which are similar to those of the elongated sanitary sleeves or cups 112. It is to be noted that the elongated sanitary sleeves or cups 112 also prevent any melted cheese, that may drip out from the dispensing nozzle portion 14 of the dispensing gun 10 from encountering the hollow aluminum tubes 120. In addition, in a manner similar to the fabrication of the external diametrical or surface dimensions of the pair of elongated sanitary sleeves or cups 112 relative to the internal diametrical or size dimensions of the pair of primary apertures 108 and the secondary slots 110 defined within the face plate 106 so as to permit the pair of elongated sanitary sleeves or cups 112 to pass through the pair of primary apertures 108 and the secondary slots 110 defined within the face plate 106 such that the elongated sanitary sleeves or cups 112 can be disposed within the appliance housing 102, the external diametrical or surface dimensions of the pair of elongated hollow aluminum tubes 120 are slightly larger than the corresponding external diametrical or surface dimensions of the pair of elongated sanitary sleeves or cups 112 such that the pair of elongated sanitary sleeves or cups 112 can be respectively disposed internally within the pair of elongated hollow aluminum tubes 120. More particularly, it is also seen that an elongated channel member 121, extending the entire axial length of each one of the pair of elongated hollow aluminum tubes 120, is formed within the lower side wall portion of each one of the pair of elongated hollow aluminum tubes 120 so as to accommodate the channel portions 116 of the elongated sanitary cups or sleeves 112. Still further, it is additionally seen that a pair of elongated flexible tubular foil heaters 122 are adapted to be respectively disposed around the external peripheral surface portion of each one of the pair of elongated hollow aluminum tubes 120.

Each one of the pair of elongated flexible tubular foil heaters 122 is provided with a heating strip or heating coil 124 which has a substantially sinusoidal configuration. The heating coils 124 can be embedded within each one of the foil heaters 122 or affixed to external peripheral surface portions of each one of the foil heaters 122. It is also noted that each one of the elongated flexible tubular foil heaters 122 does not comprise a completely closed tubular member, but to the contrary, the lower side wall portion of each one of the elongated flexible tubular foil heaters 122 is provided with an elongated slot 126 which extends throughout the entire axial length of each one of the foil heaters 122 so as to effectively permit the channel members 121 of the aluminum tubes 120 to project therethrough. In order to complete the warming appliance assembly, a pair of elongated insulation tubes 128 are adapted to respectively annularly surround the external peripheral surface portions of each one of the elongated flexible tubular foil heaters 122. In this manner, when the heating strips or coils 124 of the foil heaters 122 are energized, heat is transmitted radially inwardly from the foil heaters 122, to the aluminum tubes 120, and then to the sanitary cups or sleeves 112 which, in turn, impart heat to the dispensing guns 10,10′ whereby, for example, the semi-solid cheese products, disposed within the cheese dispensing guns 10,10′, are sufficiently heated to predetermined temperatures, such as, for example, between 145° F. and 180° F. such that the food or cheese products are not only sufficiently melted whereby the food or cheese products are provided with the requisite fluidity in order to not only permit the easy and reliable dispensing thereof, but the heat also renders the food or cheese products safe for consumption.

In order to fixedly mount the warming appliance assembly, comprising the aluminum tubes 120, the foil heaters 122, and the insulation tubes 128, within the warming appliance housing 102, a front mounting plate 130 is adapted to be fixedly mounted within the front end portion 132 of the warming appliance housing 102 by, for example, means of suitable mounting brackets and fasteners, not illustrated. It is also note that the front mounting plate 130 is provided with a pair of primary and secondary apertures or slots 134,136, which are similar to the primary and secondary apertures or slots 108,110 formed within the face plate 106 so as to similarly accommodate the passage of the tubular body portions of the sanitary cups or sleeves 112 as well as the channel portions 116 of the sanitary sleeves or cups 112. In a similar manner, it is noted that a rear mounting plate 138 is adapted to be fixedly secured within a rear end portion 140 of the warming appliance housing 102 by means of mounting brackets 142 which can be fixedly secured to internal surface portions of the rear end portion 140 of the warming appliance housing 102 by means of suitable fasteners, not shown. It is noted that the rear mounting plate 138 has a pair of circular apertures 144 defined therein, and that the distal end portions of the elongated aluminum tubes 120 have plugs 146 disposed therein. The plugs 146 are preferably fabricated from a resilient insulative material, such as, for example, a suitable rubber or neoprene, so as to effectively prevent heat from being lost axially away from the elongated aluminum tubes 120 whereby the heat will effectively be forced to radiate radially inwardly into contact with the sanitary sleeves or cups 112 so as to thereby heat the same which will, in turn, serve to heat the dispensing guns 10,10′ when the dispensing guns 10,10′ are disposed within the sanitary sleeves or cups 112. It is also seen that the plugs 146 have circular bosses 148 which are integrally formed therewith and which project axially away from the plugs 146, and toward the rear mounting plate 138, whereby it can be appreciated that these bosses 148 of the plugs 146 are adapted to be inserted within the circular apertures 144 of the rear mounting plate 138 and will engage the inner surface portion of the distal or rear end plate 104 of the warming appliance housing 102. In this manner, the entire warming appliance assembly, comprising the aluminum tubes 120, the foil heaters 122, and the insulation tubes 128, are properly positioned within the warming appliance housing 102.

It is lastly noted, with reference still being made to the explosive view of FIG. 3, that various electrical or electronic components are also provided upon, or internally within, the warming appliance housing 102 so as to in fact permit the flexible foil heaters 122 to operate as desired and required. For example, one rectangular side wall portion of the warming appliance housing 102 is provided with a square-shaped aperture or window 150 within which a printed circuit board (PCB) 152 is adapted to be mounted by means of a printed circuit board mounting plate 154. The printed circuit board 152 is mounted upon the printed circuit board mounting plate 154 and the printed circuit board mounting plate 154 is adapted to be fixedly secured to the side wall portion of the warming appliance housing 102 by means of suitable fasteners, not shown. A thermoplastic barrier or heat shield 156 is adapted to be interposed between the printed circuit board 152 and the interior of the warming appliance housing 102 such that thermoplastic barrier or heat shield 156 will effectively shield the printed circuit board 152 from residual heat generated and present within the warming appliance housing 102 so that the various components of the printed circuit board 152 are not adversely affected by such heat present within the warming appliance housing 102.

Lastly, an operator interface or control panel 158 is mounted upon the surface portion of the printed circuit board mounting plate 154 that is disposed opposite the surface portion of the printed circuit board mounting plate 154 upon which the printed circuit board 152 is mounted. The operator interface or control panel 158 may optionally have various control buttons, not shown, disposed thereon, such as, for example, START and STOP buttons for energizing or de-energizing the flexible foil heaters 122, a thermostatic control for predetermining the temperature to which the flexible foil heaters 122 are to attain so as to properly heat the aluminum tubes 120 and, in turn, the elongated sleeves or cups 112 for, in turn, imparting heat to the food or cheese dispensing guns 10,10′, so as to in fact achieve the desired melting of the cheese or food product, as well as to render such cheese or food product safe for consumption. FIG. 3 also illustrates other components of the electrical or electronic sys-tem, however, these have not been specifically discussed or referenced as they comprise conventional components, such as, for example, solid state relays, transformers, and the like, which do not comprise components of the present invention.

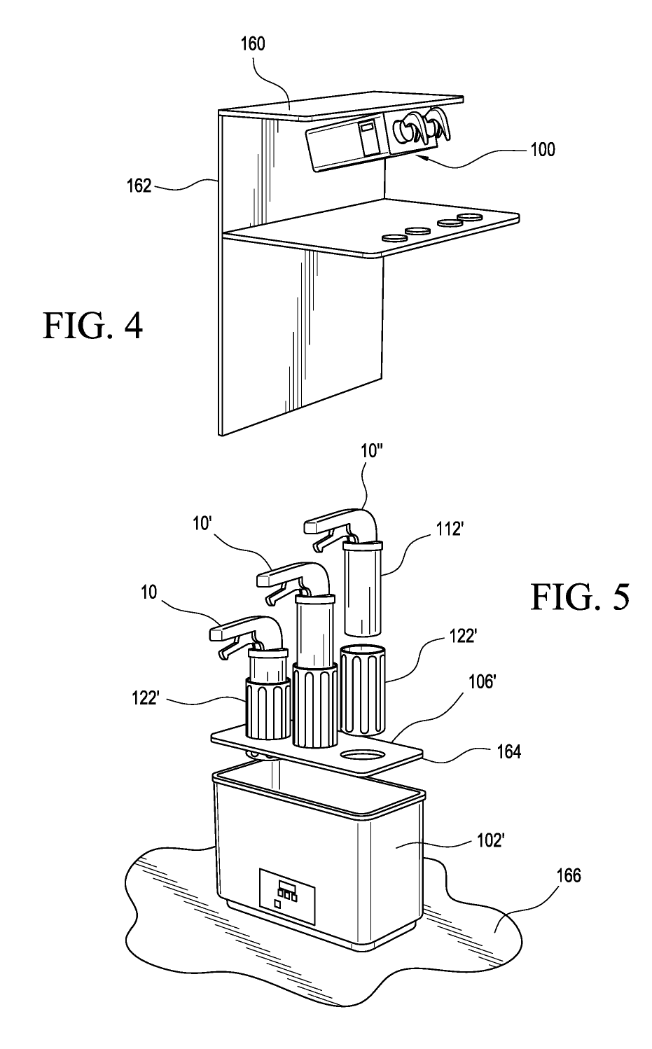

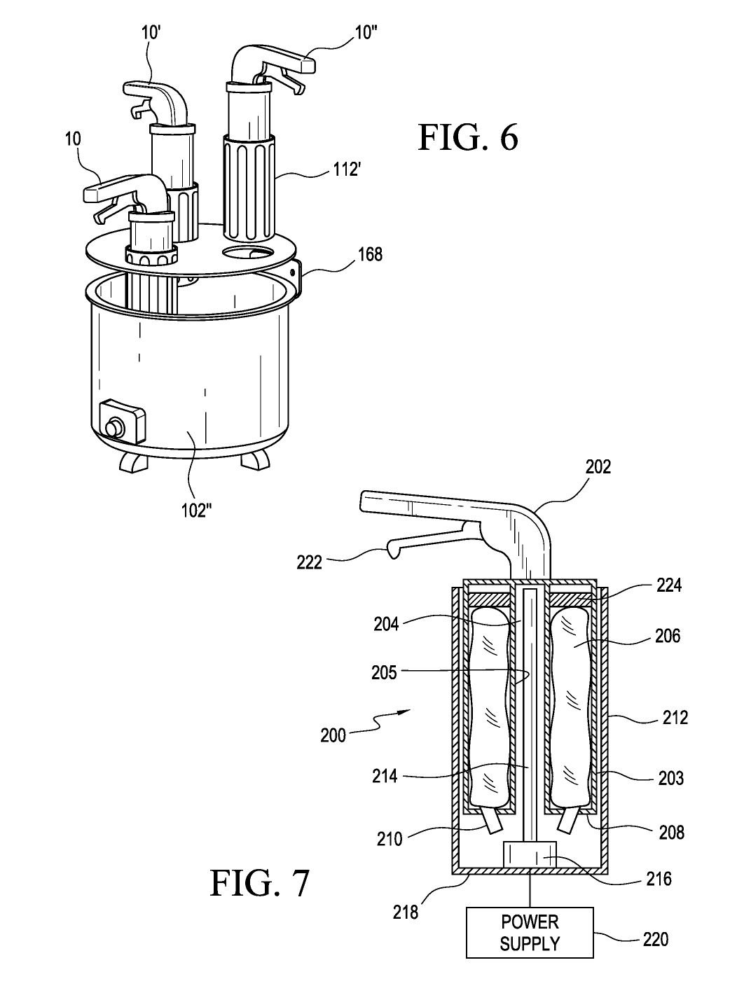

While the foregoing has described one embodiment of the present invention food warming appliance, different variations, modifications, or other embodiments of the present invention are possible in light of the above or similar teachings. For example, as disclosed within FIG. 4, the food warming appliance 100 may be fixedly mounted upon an undersurface portion of a shelf 160 which is fixedly attached to an upstanding wall 162 such that the wall 162 and shelf 160 effectively form a first embodiment upstanding independent or stand-alone food station. Alternatively, in lieu of the food warming appliance being mounted upon a shelf of a food station, the warming appliance housing can itself serve as a second embodiment independent or stand-alone food station 164 as illustrated in FIG. 5, it being noted that the distal or rear end plate of the food warming appliance housing 102′ is disposed upon a floor surface 166 while the food or cheese dispensing guns extend vertically upwardly away from the proximal, front, or top end plate 106′. It is noted that in accordance with this second embodiment of an independent or stand-alone food station, three food or cheese dispensing guns 10,10′, and 10″ are disposed within the food warming appliance housing 102′. Furthermore, it is also noted that the aluminum tubes have effectively been eliminated, whereby flexible foil heaters 122′ are adapted to circumferentially surround thermoplastic sleeves or cups 112′. Still yet further, as disclosed within FIG. 6, a third embodiment of an independent or stand-alone food station 168 comprises a food warming appliance housing 102″ which has a cylindrical configuration for housing or accommodating the three food or cheese dispensing guns 10,10′,10″.

With reference lastly being made to FIG. 7, a second embodiment of the present invention food or cheese warming appliance is schematically illustrated and is generally indicated by the reference character 200. In accordance with this embodiment of the food or cheese warming appliance 200, and in lieu of a conventional cheese dispensing gun 10 wherein the dispensing gun 10 effectively comprises a cylindrically sealed container or housing, except of course for the dispensing nozzle assembly 14, the dispensing gun 202 of this embodiment has a cylindrical blind bore 204 defined along the central longitudinal axis thereof such that the central or axial portion of the barrel 203 dispensing gun 202 is defined by means of an annular internal peripheral wall portion 205, and the food product or cheese to be melted is disposed within a suitable plastic pouch 206 which has a tubular configuration annularly surrounding the blind bore 204. A food product or cheese dispensing assembly 208 annularly surrounds the blind bore 204 and may comprise, for example, a plurality of dispensing nozzles 210 which may be disposed within a circular array annularly surrounding the blind bore 204 and which are oriented so that all of the dispensing nozzles 210 have a common convergence point toward which the dispensed food or cheese is to be discharged. The food or cheese warming appliance 200 also comprises a housing 212, whose proximal end is open, however, in lieu of the aforenoted aluminum tubes 120, the flexible foil heaters 122, the insulation tubes 128, and thermoplastic sanitary sleeves or cups 112, characteristic of the first embodiment cheese warming appliance 100 illustrated within FIG. 3, an elongated heated rod 214 is fixedly mounted upon a support base 216 which is, in turn, fixedly mounted upon an end wall 218 of the housing 212 disposed opposite the open end portion of the housing 212.

The elongated heated rod 214 is adapted to be electrically heated by means of a suitable electrical power source or power supply 220 which is electrically connected to the support base 216, and the support base 216 is, in turn, electrically connected to the heated rod 214. When the dispensing gun 202 is inserted into the appliance housing 212, the elongated heated rod 214 will be inserted into the blind bore 204 defined within the gun 202 whereby the elongated heated rod 214 will serve to impart sufficient heat to the internal peripheral wall portion 205 of the dispensing gun 202 which will, in turn, impart sufficient heat to the food product or cheese disposed within the plastic pouch 206 so that the food product or cheese is sufficiently melted and ready to be dispensed. The dispensing gun 202 can then be removed from the appliance housing 212, and disengaged from the elongated heated rod 214, where-upon actuation of the trigger mechanism 222 of the dispensing gun 202, the food product or cheese can be dispensed. It is also envisioned that the dispensing gun 202 and the appliance housing 212 can be provided with suitable electrical connectors or sensors such that the heated rod 214 is only energized when the dispensing gun 202 is disposed within the appliance housing 212, and is de-energized when the dispensing gun 202 is removed from the appliance housing 212. In addition, it is noted that the dispensing gun 202 has an annular-shaped pusher-plate member 224 such that when the trigger mechanism 222 is actuated, the annular pusher-plate mechanism 224 can move within the gun barrel 203 so as to incrementally compress the annular or tubular plastic pouch 206.

It is to be understood that within the scope of the appended claims, the present invention may be practiced otherwise than as specifically described herein.

### REFERENCE NUMBER KEY TO COMPONENTS

10—First type of conventional cheese dispensing gun
12—Barrel of first gun 10
14—Dispensing nozzle of gun 10
16—Handle of gun 10
18—Trigger mechanism of gun 10
20—Secondary barrel of gun 10 for accommodating rack component
10′—Second type of conventional cheese dispensing gun
12′—Barrel of second gun 12
14′—Dispensing nozzle of gun 12
16′—Handle of gun 12
18′—Trigger mechanism of gun 12
20′—Secondary barrel of gun 12 for accommodating rack component
100—First embodiment cheese warming appliance
102—Housing of appliance 100
104—Distal end plate of housing 102
106—Proximal face plate of housing 102
108—Pair of primary apertures defined within face plate 106
110—Pair of secondary apertures/slots defined within face plate 106
112—Pair of elongated hollow sanitary sleeves or cups
114—Primary circular openings within proximal ends of sleeves or cups 112
116—Secondary semi-circular elongated channel 116 of sleeve or cup 112
118—External flange or lip portions of sleeves or cups 112
120—Hollow aluminum tubes
121—Channels within lower side wall portions of aluminum tubes 120
122—Flexible foil heaters
124—Heating strips or heating coils of foil heaters 122
126—Slots within lower side wall portions of foil heaters 122
128—Insulation tubes
130—Front mounting plate
132—Front end portion of appliance housing 102
134—Primary aperture defined within front mounting plate 130
136—Secondary aperture defined within front mounting plate 130
138—Rear mounting plate of warming appliance housing 102
140—Rear end portion of warming appliance housing 102
142—Mounting brackets for mounting rear mounting plate upon housing 102
144—Circular apertures within rear mounting plate
146—Plugs within rear or distal ends of the aluminum tubes 120
148—Bosses integrally formed upon the plugs 146
150—Window within side wall portion of warming appliance housing 102
152—Printed circuit board
154—Printed circuit board mounting plate
156—Thermoplastic barrier or heat shield
158—Operator interface or control panel
160—Shelf
162—Upstanding wall of first embodiment stand-alone food station
164—Second embodiment stand-alone food station containing three guns
166—Floor surface upon which food station 164 is supported
168—Third embodiment stand-alone food station
200—Second embodiment cheese warming appliance
202—Dispensing gun of appliance 200
203—Dispensing gun barrel
204—Cylindrical blind bore of dispensing gun 202
205—Internal peripheral wall portion of dispensing gun barrel 203
206—Annular cheese pouch of dispensing gun 202
208—Dispensing assembly of dispensing gun 202
210—Dispensing nozzles of dispensing assembly 208
212—Housing of appliance 200
214—Elongated heated rod disposed within housing 212
216—Support base for heated rod 214
218—End wall of housing 212 upon which support base 216 is mounted
220—Electrical power source or power supply for heated rod 214
222—Trigger mechanism of dispensing gun 202

What is claimed as new and desired to be protected by Letters Patent, is:

1. A food warming appliance for warming food products to be dispensed by a food dispensing gun containing a food product to be dispensed, comprising:
a housing for accommodating at least one food dispensing gun; and
at least one heater element operatively associated with the at least one food dispensing gun such that when said at least one heater element is energized, said at least one heater element generates sufficient heat for heating the at least one food dispensing gun so as to, in turn, sufficiently heat the food product disposed within the at least one food dispensing gun whereby the heated food product can be dispensed from the at least one food dispensing gun.

2. A food warming appliance as set forth in claim 1, further comprising:
at least one sanitary sleeve/cup disposed internally within said at least one heater element and capable of accommodating the barrel portion of the at least one food dispensing gun containing the food product to be dispensed such that when the barrel portion of the at least one food dispensing gun is disposed within said at least one sanitary sleeve/cup, and said at least one heater element is energized, said at least one heater element generates heat for heating said at least one sanitary sleeve/cup which, in turn, heats the barrel portion of the at least one food dispensing gun disposed within said at least one sanitary sleeve/cup so as to sufficiently heat the food product disposed within the at least one food dispensing gun whereby the heated food product can be dispensed from the at least one food dispensing gun.

3. The food warming appliance as set forth in claim 1, wherein:
said at least one heater element comprises a flexible foil heater element.

4. The food warming appliance as set forth in claim 3, wherein:
said flexible foil heater element has sinusoidal heater strips/heater coils embedded within/attached to said flexible foil heater.

5. The food warming appliance as set forth in claim 2, wherein:
said at least one sanitary sleeve/cup is fabricated from a suitable thermoplastic material.

6. The food warming appliance as set forth in claim 2, wherein:
said at least one sanitary sleeve/cup is removably disposed within said at least one heater element so as to be removed from said food warming appliance for cleaning any food product that may collect within said at least one sanitary sleeve/cup as a result of discharge from the at least one food dispensing gun.

7. The food warming appliance as set forth in claim 2, further comprising:
at least one metal tube disposed internally within said at least one heater element and annularly surrounding said at least one sanitary sleeve/cup such that when the barrel portion of the at least one dispensing gun is disposed within said at least one sanitary sleeve/cup, and said at least one heater element is energized, said at least one heater element generates heat for heating said at least one metal tube and said at least one metal tube generates heat for heating said at least one sanitary sleeve/cup which, in turn, heats the barrel portion of the at least one dispensing gun disposed within said at least one sanitary sleeve/cup so as to sufficiently heat the food product disposed within the at least one dispensing gun whereby the heated food product can be dispensed from the dispensing gun.

8. The food warming appliance as set forth in claim 7, wherein:
said at least one metal tube is fabricated from aluminum.

9. The food warming appliance as set forth in claim 7, further comprising:
at least one insulation tube annularly surrounding said at least one heater element.

10. The food warming appliance as set forth in claim 9, wherein:
said at least one insulation tube, said at least one heater element, said at least one metal tube, and said at least one sanitary sleeve/cup respectively comprise a pair of insulation tubes, a pair of heater elements, a pair of metal tubes, and a pair of sanitary sleeves/cups for accommodating a pair of food dispensing guns.

11. The food warming appliance as set forth in claim 1, wherein:
said housing of said food warming appliance is fixedly mounted upon an upstanding wall such that said food warming appliance, as fixedly mounted upon said upstanding wall, effectively serves as a stand-alone food dispensing station.

12. The food warming appliance as set forth in claim 2, wherein:
said housing of said food warming appliance is disposed upon a floor surface such that said food warming appliance, as disposed upon said floor surface, effectively serves as a stand-alone food dispensing station.

13. The food warming appliance as set forth in claim 12, wherein:
said at least one heater element, and said at least one sanitary sleeve/cup respectively comprise three heater elements and three sanitary sleeves/cups for accommodating three food dispensing guns.

14. The food warming appliance as set forth in claim 13, wherein:
said housing of said food warming appliance has a configuration which is that of a rectangular parallelepiped.

15. The food warming appliance as set forth in claim 13, wherein:
said housing of said food warming appliance has a cylindrical configuration.

16. A food warming appliance for warming food products to be dispensed by a food dispensing gun containing a food product to be dispensed, comprising:
a housing having a first open end for receiving a food dispensing gun; and
a heater element fixedly secured to a second end of said housing and extending toward said first open end of said housing for disposition internally within the food dispensing gun when the food dispensing gun is inserted into said housing such that said heater element heats an internal peripheral wall portion of the food dispensing gun which, in turn, heats the food product contained within the food dispensing gun such that the food product can be dispensed from the food dispensing gun.
